(19) United States
(12) Patent Application Publication
(10) Pub. No.: US 2025/0181803 A1
(43) Pub. Date: Jun. 5, 2025

(54) SIMULATING PHYSICAL ENVIRONMENTS USING FINE-RESOLUTION AND COARSE-RESOLUTION MESHES

(71) Applicant: DeepMind Technologies Limited, London (GB)

(72) Inventors: Meire Fortunato, London (GB); Tobias Pfaff, London (GB); Peter Wirnsberger, London (GB); Alexander Pritzel, London (GB); Peter William Battaglia, London (GB)

(21) Appl. No.: 18/868,017

(22) PCT Filed: May 23, 2023
(86) PCT No.: PCT/EP2023/063755

§ 371 Date: Nov. 21, 2024

Related U.S. Application Data
(60) Provisional application No. 63/344,910, filed on May 23, 2022.

(51) Int. Cl. G06F 30/27

(52) U.S. Cl. CPC G06F 30/27

(57) ABSTRACT

Methods, systems, and apparatus, including computer programs encoded on a computer storage medium, for simulating a state of a physical environment. In one aspect, a method performed by one or more computers for simulating the state of the physical environment is provided. The method includes, for each of multiple time steps: obtaining data defining a fine-resolution mesh and a coarse-resolution mesh that each characterize the state of the physical environment at the current time step, where the fine-resolution mesh has a higher resolution than the coarse-resolution mesh; processing data defining the fine-resolution mesh and the coarse-resolution mesh using a graph neural network that includes: (i) one or more fine-resolution update blocks, (ii) one or more coarse-resolution update blocks, and (iii) one or more up-sampling update blocks; and determining the state of the physical environment at a next time step using updated node embeddings for nodes in the fine-resolution mesh.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a simulation system implemented as computer programs on one or more computers in one or more locations that can simulate a state of a physical environment over a sequence of time steps using a graph neural network. In particular, this specification introduces a simulation system that can accurately predict (simulate) a broad range of physical environments in high-resolution settings using graph neural networks.

Some implementations of the described techniques are adapted to specific computing hardware. For example, techniques are described that enable a mesh-based simulation to be divided into updates on a fine-resolution mesh and a coarse-resolution mesh that are used by the simulation system to simulate a state of a physical environment. This in turn enables the simulation system to take advantage of computer systems that include higher and lower capability processors, e.g., in terms of computing capability such as FLOPS (floating point operations per second) or available working memory, to optimally allocate computing resources for updates on the fine-resolution and coarse-resolution meshes.

In one aspect, a method performed by one or more computers for simulating a state of a physical environment is provided. The method includes, for each of multiple time steps: obtaining data defining a fine-resolution mesh and a coarse-resolution mesh that each characterize the state of the physical environment at the current time step, where the fine-resolution mesh has a higher resolution than the coarse-resolution mesh; processing data defining the fine-resolution mesh and the coarse-resolution mesh using a graph neural network; and determining the state of the physical environment at a next time step using updated node embeddings for nodes in the fine-resolution mesh. The graph neural network includes: (i) one or more fine-resolution update blocks, (ii) one or more coarse-resolution update blocks, and (iii) one or more up-sampling update blocks. Each fine-resolution update block is configured to process data defining the fine-resolution mesh using a graph neural network layer to update a current node embedding of each node in the fine-resolution mesh. Each coarse-resolution update block is configured to process data defining the coarse-resolution mesh using a graph neural network layer to update a current node embedding of each node in the coarse-resolution mesh. Each up-sampling update block is configured to: generate data defining an up-sampling mesh that comprises: (i) each node from the fine-resolution mesh and each node from the coarse-resolution mesh, and (ii) multiple edges between the nodes of the fine-resolution mesh and the nodes of the coarse-resolution mesh; and process data defining the up-sampling mesh using a graph neural network layer to update the current node embedding of each node in the fine-resolution mesh.

In some implementations, generating the up-sampling mesh includes, for each node of the coarse-resolution mesh: identifying a cell of the fine-resolution mesh that includes the node of the coarse-resolution mesh; identifying one or more nodes in the fine-resolution mesh that are vertices of the cell that includes the node of the coarse-resolution mesh; and instantiating a respective edge, in the up-sampling mesh, between the node of the coarse resolution mesh and each of the identified nodes in the fine-resolution mesh.

In some implementations, the method further includes, for each edge in the up-sampling mesh: generating an edge embedding for the edge based on a distance between a pair of nodes in the up-sampling mesh that are connected by the edge.

In some implementations, processing data defining the up-sampling mesh using a graph neural network layer to update the current node embedding of each node in the fine-resolution mesh includes: updating an edge embedding for each edge in the up-sampling mesh based on: (i) the edge embedding for the edge, and (ii) respective node embeddings of a first node in the coarse-resolution mesh and a second node in the fine-resolution mesh that are connected by the edge; and updating the node embedding for each node in the fine-resolution mesh based on: (i) the node embedding for the node in the fine-resolution mesh, and (ii) respective edge embeddings of each edge that connects the node in the fine-resolution mesh to a corresponding node in the coarse-resolution mesh.

In some implementations, each up-sampling block updates the current node embeddings of the nodes in the fine-resolution mesh based at least in part on the current node embeddings of the nodes in the coarse-resolution mesh.

In some implementations, the graph neural network further includes one or more down-sampling update blocks. Each down-sampling update block is configured to: generate data defining a down-sampling mesh that comprises: (i) each node from the fine-resolution mesh and each node from the coarse-resolution mesh, and (ii) multiple edges between the nodes of the fine-resolution mesh and the nodes of the coarse-resolution mesh; and process data defining the down-sampling mesh using a graph neural network layer to update the current node embedding of each node in the coarse-resolution mesh.

In some implementations, generating the down-sampling mesh includes, for each node of the fine-resolution mesh: identifying a cell of the coarse-resolution mesh that includes the node of the fine-resolution mesh; identifying one or more nodes of the coarse-resolution mesh that are vertices of the cell that includes the node of the fine-resolution mesh; and instantiating a respective edge, in the down-sampling mesh, between the node of the fine-resolution mesh and each of the identified nodes of the coarse-resolution mesh.

In some implementations, the method further includes, for each edge in the down-sampling mesh: generating an edge embedding for the edge based on a distance between a pair of nodes in the down-sampling mesh that are connected by the edge.

In some implementations, processing data defining the down-sampling mesh using a graph neural network layer to update the current node embedding of each node in the coarse-resolution mesh includes: updating an edge embedding for each edge in the down-sampling mesh based on: (i) the edge embedding for the edge, and (ii) respective node embeddings of a first node in the coarse-resolution mesh and a second node in the fine-resolution mesh that are connected by the edge; and updating the node embedding for each node in the coarse-resolution mesh based on: (i) the node embedding for the node in the coarse-resolution mesh, and (ii) respective edge embeddings of each edge that connects the node in the coarse-resolution mesh to a corresponding node in the fine-resolution mesh.

In some implementations, each down-sampling block updates the current node embeddings of the nodes in the coarse-resolution mesh based at least in part on the current node embeddings of the nodes in the fine-resolution mesh.

In some implementations, the graph neural network has been trained on a set of training examples, where one or more of the training examples are generated by operations including: generating a target simulation of a state of a training physical environment over one or more time steps using a simulation engine, wherein the target simulation has a higher resolution than the fine-resolution mesh processed by the graph neural network; generating a lower-resolution version of the target simulation by interpolating the target simulation to a same resolution as the fine-resolution mesh processed by the graph neural network; and generating the training examples using the lower-resolution version of the simulation mesh.

In some implementations, obtaining data defining the state of the physical environment at the current time step includes, for each node in the fine-resolution mesh: obtaining one or more node features for the node, where the node corresponds to a position in the physical environment, and where the node features characterize a state of the corresponding position in the physical environment; and processing the node features using one or more neural network layers of the graph neural network to generate the current embedding for the node.

In some implementations, for each node in the fine-resolution mesh, the node features for the node comprise one or more of: a fluid density feature, a fluid viscosity feature, a pressure feature, or a tension feature.

In some implementations, the graph neural network further includes a decoder block, and where determining the state of the physical environment at the next time step includes: processing the updated node embedding for each node in the fine-resolution mesh to generate one or more respective dynamics features corresponding to each node in the fine-resolution mesh; and determining the state of the physical environment at the next time step based on: (i) the dynamics features for the nodes in the fine-resolution mesh, and (ii) the node features for the nodes in the fine-resolution mesh at the current time step.

In some implementations, the fine-resolution mesh and the coarse-resolution mesh are each three-dimensional meshes.

In some implementations, the fine-resolution mesh and the coarse-resolution mesh are each triangular meshes.

In some implementations, the fine-resolution mesh and the coarse-resolution mesh each span the physical environment.

In some implementations, for each time step, a number of nodes in the fine-resolution mesh is greater than a number of nodes in the coarse-resolution mesh.

In some implementations, the method is performed on a computing system including a first processor and a second processor, where the second processor has a higher processing capability or memory than the first processor. The method includes: processing data defining the fine-resolution mesh by implementing the one or more fine-resolution update blocks on the second processor; and processing data defining the coarse-resolution mesh by implementing the one or more coarse-resolution update blocks on the first processor.

In some implementations, the method further includes: processing data defining the fine-resolution mesh by implementing the one or more fine-resolution update blocks on the second processor; then processing data defining the down-sampling mesh to update the current node embedding of each node in the coarse-resolution mesh; then processing data defining the coarse-resolution mesh by implementing the one or more coarse-resolution update blocks on the first processor; then processing data defining the up-sampling mesh to update the current node embedding of each node in the fine-resolution mesh.

In a second aspect, a method of controlling a robot using any of the abovementioned methods is provided. The physical environment includes a real-world environment including a physical object. Obtaining the data defining the fine-resolution mesh and the coarse-resolution mesh that each characterize the state of the physical environment at the current time step includes determining a representation of a location, a shape, or a configuration of the physical object at the current time step. Determining the state of the physical environment at the next time step includes determining a predicted representation of the location, the shape, or the configuration of the physical object at the next time step. The method further includes, at each time step: controlling the robot using the predicted representation at the next time step to manipulate the physical object.

In a third aspect, a system is provided. The system includes one or more non-transitory computer storage media storing instructions that when executed by one or more computers cause the one or more computers to perform operations of any of the abovementioned methods.

In a fourth aspect, a system is provided. The system includes: one or more computers; and one or more storage devices communicatively coupled to the one or more computers. The one or more storage devices store instructions that, when executed by the one or more computers, cause the one or more computers to perform operations of any of the abovementioned methods.

Graph neural networks use message-passing between nodes to propagate information and iteratively update their node embeddings by the exchange of information with neighboring nodes. However, this structure becomes a limiting factor for high-resolution simulations, as equally distant points in space become further apart in graph space. To address this, the simulation system can train a graph neural network to learn accurate surrogate dynamics of a high-resolution physical environment on a lower resolution mesh, both removing the message-passing bottleneck and improving performance. Moreover, the simulation system also introduces a hierarchical approach by passing messages on two meshes with different resolutions, i.e., a fine-resolution mesh and a coarse-resolution mesh, which significantly improves the accuracy of graph neural networks while requiring less computational resources.

The physical environment can be, e.g., a continuous field or a deformable material. A continuous field can refer to, e.g., a spatial region where each position in the spatial region is associated with one or more physical quantities, e.g., velocity, pressure, etc.

A “mesh” refers to a data structure that includes a set of nodes and a set of edges, where each edge connects a respective pair of nodes. The mesh can define an irregular (unstructured) grid that specifies a tessellation of a geometric domain (e.g., a surface or space) into smaller elements (e.g., cells, or zones) having a particular shape (e.g., a triangular or tetrahedral shape). Each node can be associated with a respective spatial location in the physical environment.

The “resolution” of a mesh can refer to, e.g., a number of nodes in the mesh and/or a node density in the mesh. The node density of a mesh can refer to a number of nodes per length if the mesh is one-dimensional, a number of nodes per area if the mesh is two-dimensional, a number of nodes per volume if the mesh is three-dimensional, and so on.

At each time step, the simulation system generates an initial node embedding for each node of the fine-resolution mesh and the coarse-resolution mesh, and then repeatedly updates the node embeddings of the nodes of the fine-resolution mesh and the coarse resolution mesh using update blocks of the graph neural network. In particular, each update block of the graph neural network receives the fine-resolution mesh and/or the coarse-resolution mesh, updates the current node embeddings for the nodes of the fine-resolution mesh or the coarse-resolution mesh, and then provides the fine-resolution mesh and/or the coarse-resolution mesh to a next update block in the graph neural network.

Throughout this specification, an “embedding” of an entity can refer to a representation of the entity as an ordered collection of numerical values, e.g., a vector or matrix of numerical values, in a latent space (e.g., a lower-dimensional space). An embedding of an entity can be generated, e.g., as the output of a neural network that processes data characterizing the entity. Note, an embedding of an entity is often referred to as a latent representation of the entity, an encoded representation of the entity, or a feature vector representation of the entity, depending on the context.

Simulations generated by the simulation system described in this specification (e.g., that characterize predicted states of a physical environment over a sequence of time steps) can be used for any of a variety of purposes. In some cases, a visual representation of the simulation may be generated, e.g., as a video, and provided to a user of the simulation system. In some cases, a representation of the simulation may be processed to determine that a feasibility criterion is satisfied, and a physical apparatus or system may be constructed in response to the feasibility criterion being satisfied. For example, the simulation system may generate an aerodynamics simulation of airflow over an aircraft wing, and the feasibility criterion for physically constructing the aircraft wing may be that the force or stress on the aircraft wing does not exceed a threshold. In some cases, an agent (e.g., a reinforcement learning agent, or a robotic agent) interacting with a physical environment may use the simulation system to generate one or more simulations of the environment that simulate the effects of the agent performing various actions in the environment. In these cases, the agent may use the simulations of the physical environment as part of determining whether to perform certain actions in the environment.

The subject matter described in this specification can be implemented in particular embodiments so as to realize one or more of the following advantages.

Realistic simulators of complex physics are invaluable to many scientific and engineering disciplines. However, conventional simulators can be prohibitively expensive to create and use. Building a conventional simulator can entail years of engineering effort, and often must trade off generality for accuracy in a narrow range of settings. Furthermore, high-quality simulators often require substantial computational resources, which makes scaling up difficult or infeasible. The simulation system described in this specification can generate simulations of complex physical environments over large numbers of time steps with greater accuracy and using fewer computational resources (e.g., memory and computing power) than some conventional simulators. In certain situations, the simulation system can generate simulations one or more orders of magnitude faster than conventional simulators. For example, the simulation system can predict the state of a physical environment at a next time step by a single pass through a graph neural network, while conventional simulators may be required to perform a separate optimization at each time step.

The simulation system generates simulations using a graph neural network that can learn to simulate complex physics directly from training data, and can generalize implicitly learned physics principles to accurately simulate a broader range of physical environments under different conditions than are directly represented in the training data. This also allows the system to generalize to larger and more complex settings than those used in training. In contrast, some conventional simulators require physics principles to be explicitly programmed, and must be manually adapted for the specific characteristics of each environment being simulated.

The simulation system can perform mesh-based simulations, e.g., where the state of the physical environment at each time step is represented by a mesh. Performing mesh-based simulations can enable the simulation system to simulate certain physical environments more accurately than would otherwise be possible, e.g., physical environments that include deforming surfaces or volumes that are challenging to model as a cloud of disconnected particles.

However, generating an accurate mesh-based simulation of the state of a physical environment can require increasing the resolution of the mesh. As the resolution of the mesh increases, nodes in the mesh that are separated by the same distance in the frame of reference of the physical environment are separated by a greater distance in the frame of reference of the mesh. (The distance between two nodes in the frame of reference of the mesh characterizes, e.g., the minimum number of edges separating the two nodes in the mesh). Thus, if the simulation is performed by processing the mesh using a graph neural network, then increasing the resolution of the mesh requires the graph neural network to include a larger number of graph neural network layers in order to propagate information over the same physical distance. However, increasing the number of graph neural network layers increases consumption of computational resources by the graph neural network, and increases the likelihood that the graph neural network will over-smooth the node embedding associated with the nodes in the mesh (which can result in lower simulation accuracy).

The simulation system described in this specification addresses this issue by simulating the state of the physical environment using a fine-resolution mesh and a coarse-resolution mesh, i.e., where the fine-resolution mesh has a higher resolution than the coarse-resolution mesh. The higher resolution of the fine-resolution mesh enables highly accurate simulation of local effects in the physical environment. The lower resolution of the coarse-resolution mesh enables information sharing between distant nodes in the coarse-resolution mesh, e.g., as the coarse-resolution mesh is processed using graph neural network layers. The simulation system leverages the complementary advantages of the fine-resolution mesh and the coarse-resolution mesh by enabling information sharing along edges connecting the nodes in the fine-resolution mesh to the nodes in the coarse-resolution mesh. Thus, by simulating the state of the physical environment using both a fine-resolution mesh and a coarse-resolution mesh, the simulation system can significantly improve simulation accuracy while reducing use of computational resources.

The simulation system can train a graph neural network used to perform mesh-based simulation on a set of training data. To generate the training data, the simulation system can use a simulation engine (e.g., a physics engine) to simulate the state of the physical environment at a higher resolution than the fine-resolution mesh processed by the graph neural network. The simulation system can then generate a lower resolution version of the simulation by interpolating the simulation to the resolution of the fine-resolution mesh processed by the graph neural network, and generate training data based on the lower resolution version of the simulation. Generating the training data in this manner can increase the accuracy of the training data, thereby enabling a graph neural network trained on the training data to achieve a higher simulation accuracy.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example simulation system that can simulate a state of a physical environment using a graph neural network.

FIG. 1B is an illustration of example fine-resolution and coarse-resolution meshes characterizing a state of a physical environment.

FIG. 2A is an illustration showing operations of an example fine-resolution update block.

FIG. 2B is an illustration showing operations of an example coarse-resolution update block.

FIG. 2C is an illustration showing operations of an example up-sampling update block.

FIG. 2D is an illustration showing operations of an example down-sampling update block.

FIGS. 3A and 3B are block diagrams of example updater module topologies using different sequences of update blocks.

FIG. 4 is an illustration showing examples of a low-resolution simulation, a high-resolution simulation, and a lower-resolution version of the high-resolution simulation.

FIG. 5 is a flow diagram of an example process for simulating a state of a physical environment using a graph neural network.

FIGS. 6A and 6B are plots of experimental data showing mean squared error versus minimum edge length for two simulation systems using different updater module topologies.

Like reference numbers and designations in the various drawings indicate like elements.

### DETAILED DESCRIPTION

Replacing costly traditional numerical solvers with learned simulators may be advantageous, e.g., because learned simulators have the potential to be much faster than classical methods. Furthermore, learned simulators can be differentiable by construction, which opens up interesting avenues for inverse design. A recent approach to learning simulations discretized on unstructured meshes is MeshGraphNets (see, e.g., Pfaff, T., et al. “Learning mesh-based simulation with graph networks,” 9th International Conference on Learning Representations, 2021), which encodes the simulation mesh at each time step into a graph, and uses message-passing graph neural networks (see, e.g., Scarselli, F., et al. “The graph neural network model,” IEEE Transactions on Neural Networks, 20(1):61-80, 2008) to make predictions on this graph. MeshGraphNets demonstrate strong generalization and accurate predictions on a broad range of physical systems.

The accuracy of traditional solvers is often limited by the resolution of the simulation mesh. This is particularly true for chaotic systems like fluid dynamics: processes at very small length-scales, such as turbulent mixing, affect the overall flow and generally need to be resolved on very fine meshes to accurately solve the underlying partial differential equation (PDE). This leads to the characteristic spatial convergence; where simulation accuracy increases monotonically with the mesh resolution. This is an important property for the use of numerical solvers in practice, as it allows trading in compute to obtain the desired solution accuracy.

However, a similar phenomenon may not apply to learned simulation approaches, particularly graph neural network models like MeshGraphNets, e.g., because as the mesh becomes finer, message-passing graph neural networks perform more update steps to propagate information along the same physical distance. This results in significantly higher computational cost, reduced accuracy at high resolutions, and may also cause over-smoothing.

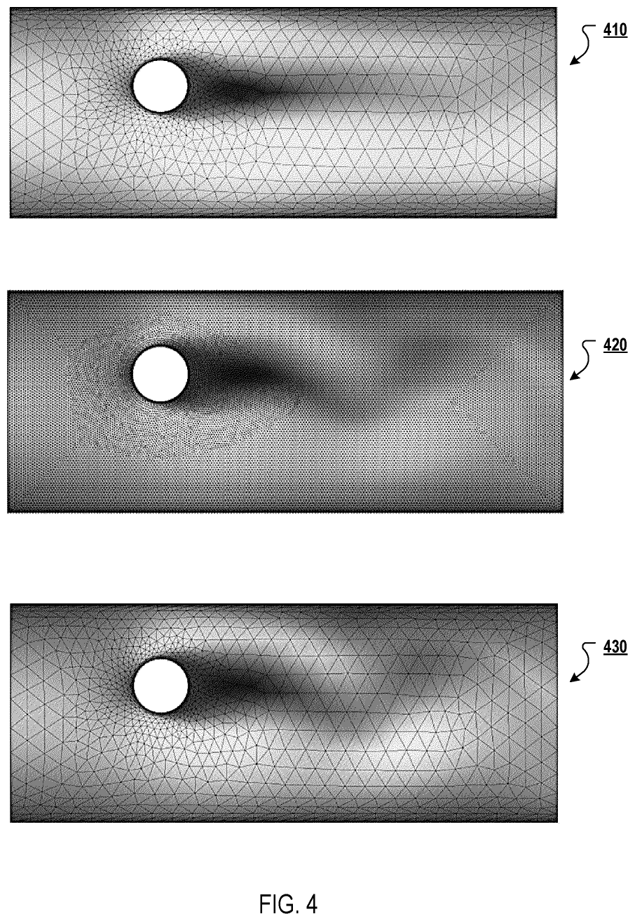

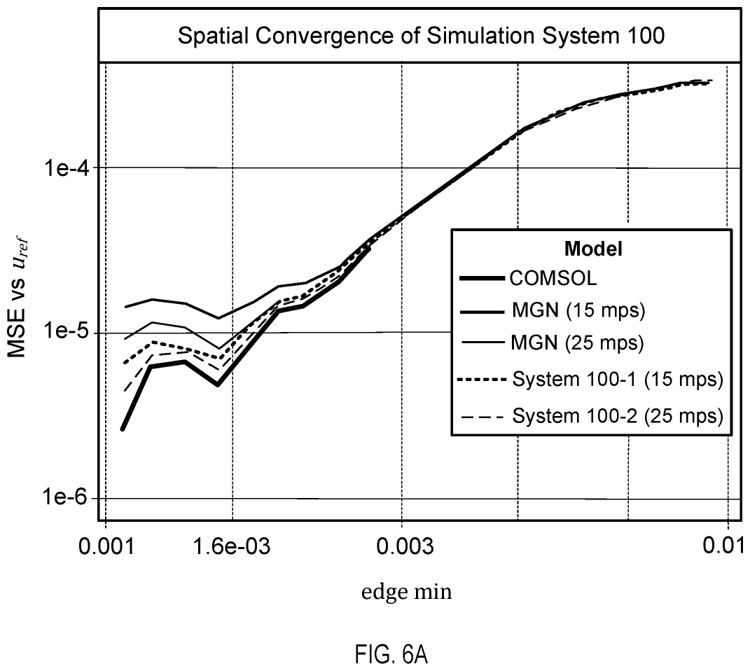

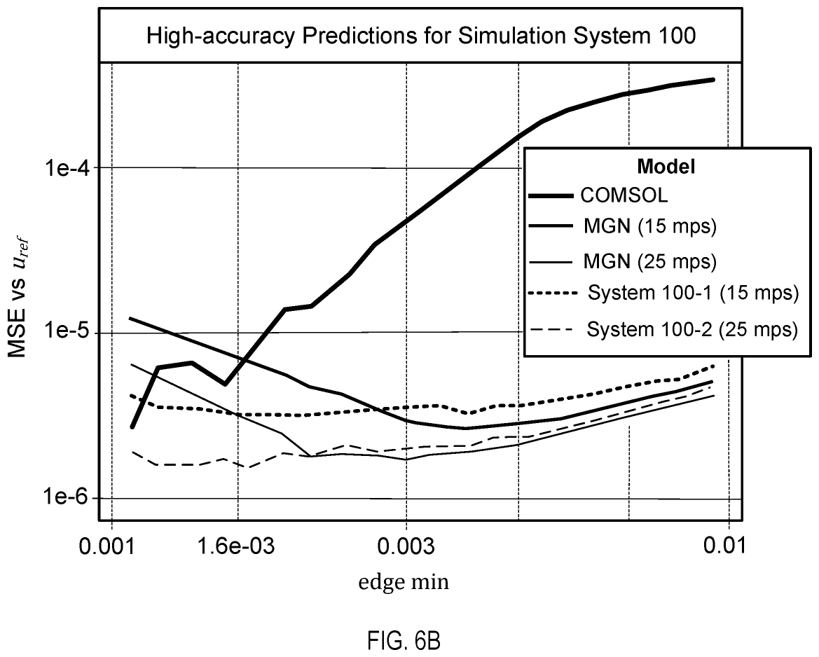

To address these issues, this specification introduces a simulation system implementing a hierarchical framework for learning mesh-based simulations using graph neural networks, which runs message-passing at two different resolutions. Namely, the simulation system implements message-passing on a fine-resolution mesh and a coarse-resolution mesh that facilitates the propagation of information. The simulation system restores spatial convergence for graph neural network models (see FIG. 6A for example), in addition to being more accurate and computationally efficient than traditional approaches (see FIG. 6B for example). Moreover, the simulation system modifies the training distribution to use high-accuracy predictions that better capture the dynamics of the physical environment being simulated (see FIG. 4 for example). As opposed to replicating the spatial convergence curve of traditional solvers, this allows the simulation system to make better predictions than the reference simulation engine (e.g., a physics engine) at a given resolution. Together, these approaches improve accuracy for highly resolved simulations at a lower computational cost.

These features and other features are described in more detail below.

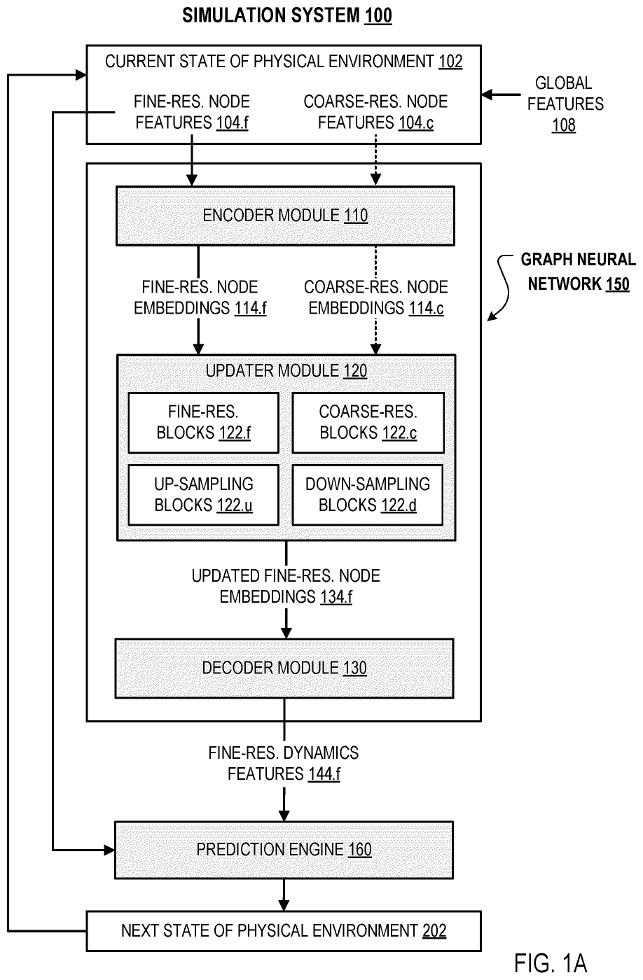

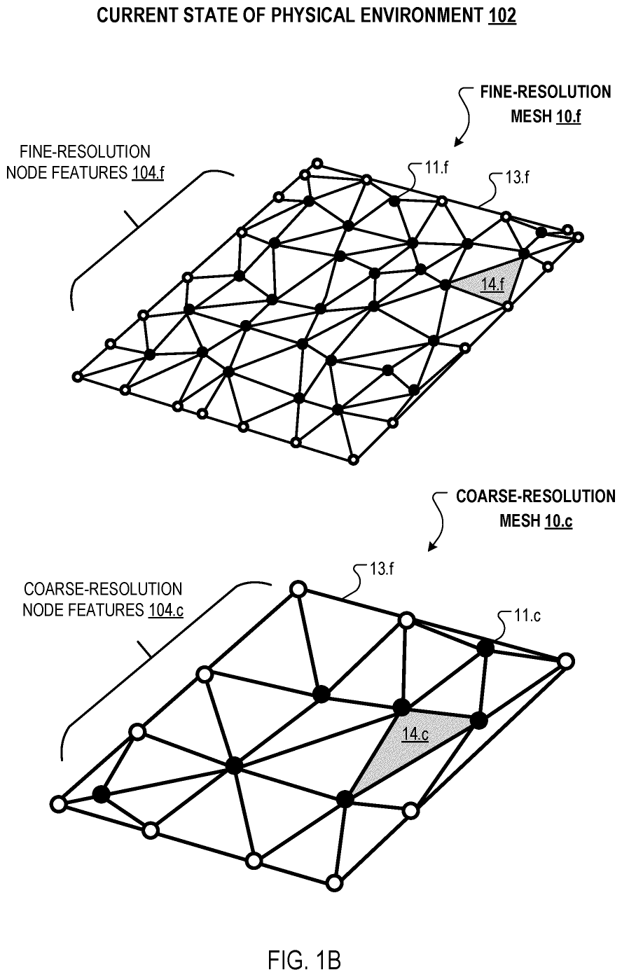

FIG. 1A shows an example simulation system 100 that can simulate a state of a physical environment using a graph neural network 150. The simulation system 100 is an example of a system implemented as computer programs on one or more computers in one or more locations in which the systems, components, and techniques described below are implemented.

A “physical environment” can refer to any type of physical system including, e.g., a fluid, a rigid solid, a deformable material, any other type of physical system or a combination thereof. A “simulation” of the physical environment can include a respective simulated state of the physical environment at each time step in a sequence of time steps. The state of the physical environment at a time step can be represented as a mesh (or multiple meshes with different resolutions), as seen in FIG. 1B and described in more detail below. The state of the physical environment at an initial time step can be provided as an input to the simulation system 100, e.g., by a user of the simulation system 100, e.g., through a user interface or application programming interface (API) made available by the simulation system 100. At each time step in the sequence of time steps, the simulation system 100 can process data defining the current state of the physical environment 102 and generate a prediction of the state of the physical environment at a next time step 202.

While some physical environments, e.g., those that include fluids, can be effectively simulated as a set of individual particles, other physical environments, e.g., those that include deformable materials and complex structures, may be more challenging to simulate in the same manner. In particular, simulating such physical environments through particle representations can be computationally inefficient and prone to failure, e.g., producing inaccurate predictions. Instead, such physical environments can be more appropriately represented by a mesh that can span the whole of the physical environment, a particular region of the physical environment, or represent respective surfaces of one or more objects in the physical environment.

The simulation system 100 can be used to simulate the dynamics of different physical environments through mesh-based representations. It should be understood that the example physical environments described below are provided for illustrative purposes only, and the simulation system 100 can be used to simulate the states of any type of physical environment including any type of material or physical object.

To simulate such physical environments, at each time step, the simulation system 100: processes data defining a current state of the physical environment 102, where such data specifies respective current node features 104.f and 104.c for nodes in a fine-resolution and a coarse-resolution mesh; encodes the data into respective current node embeddings 114.f and 114.c for the nodes; sequentially updates the respective current node embeddings 114.f and 114.c to generate final updated node embeddings 134.f for nodes in the fine-resolution mesh; decodes the final updated node embeddings 134.f to generate dynamics features 144.f for nodes in the fine-resolution mesh; and predicts the next state of the physical environment 202 based on the current node features 104.f (and in some cases one or more previous node features) and the dynamics features 144.f for nodes in the fine-resolution mesh. Various aspects of this process are described in more detail below.

Physical environments that include, e.g., continuous fields, deformable materials, and/or complex structures, can be represented by a mesh G=(V, E), e.g., an undirected graph. The mesh is defined over the spatial domain of the physical environment D⊂ [symbol] ⁿ, where n is the dimension of the physical environment. The physical environment can be a one-dimensional physical environment (e.g., a spring, a linear polymer), a two-dimensional physical environment (e.g., a superfluid, a membrane), a three-dimensional physical environment (e.g., an aircraft wing, a trapped ion), or in some cases a higher-dimensional physical environment of more than three dimensions (e.g., ten-dimensional supergravity). A “continuous field” generally refers to a spatial region associated with a physical quantity (e.g., velocity, pressure, temperature, electromagnetic field, probability amplitude, etc.) that varies continuously across the region. For example, each spatial location in a velocity field can have a particular value of velocity, e.g., a direction and a magnitude, associated with it. As another example, each spatial location in an electromagnetic field can have a particular value of electric and magnetic fields, e.g., respective directions and magnitudes, associated with it. A continuous field may be a real, an imaginary, or a complex field depending on the problem. For example, each spatial location in a probability amplitude of an electron can have a complex value associated with it.

Generally, a “mesh” refers to a data structure that includes a set of nodes V and a set of edges E, where each edge connects a pair of nodes. The mesh can define an irregular (unstructured) grid that specifies a tessellation of a geometric domain (e.g., a surface or space) into smaller elements (e.g., cells or zones) having a particular shape, e.g., a triangular shape, or a tetrahedral shape. Each node can be associated with a respective spatial location in the physical environment. In some implementations, the mesh can represent a respective surface of one or more objects in the environment. In some implementations, the mesh can span (e.g., cover) the physical environment, e.g., if the physical environment represents a continuous field.

For ease of description, the physical environment is assumed to evolve according to Eulerian dynamics over a fixed mesh, thus the simulation system 100 does not need to consider world edges in the mesh. However, the simulation system 100 can also be adapted for physical environments evolving according to Lagrangian dynamics where, e.g., a mesh represents a moving and deforming surface or volume. In these cases, a set of world edges E^{W} can be included in the mesh G=(V, E, E^{W}) to enable modeling of external dynamics, e.g., (self-) collision and contact. For example, in implementations where the mesh represents one or more objects in the physical environment, the simulation system 100 can identify each pair of nodes in the mesh that have respective spatial positions which are separated by a distance that is less than a threshold distance in world-space W (e.g., in the reference frame of the physical environment) and instantiate a world edge between each corresponding pair of nodes in the mesh. In particular, the simulation system 100 can instantiate world edges between pairs of nodes that are not already connected by an edge. Representing the current state of the physical environment 102 through both edges and world edges allows the simulation system 100 to simulate interactions between a pair of nodes that are substantially far removed from each other in mesh-space (e.g., that are separated by multiple other nodes and edges) but are substantially close to each other in world-space (e.g., that have proximate spatial locations in the reference frame of the physical environment). Including world edges in the mesh can facilitate more efficient message-passing between spatially-proximate nodes. Thus, word edges can allow more accurate simulation using fewer update iterations (i.e., message-passing steps) in the updater module 120, thereby reducing consumption of computational resources during simulation.

Each node in a mesh i∈V can be associated with current node features fᵢ(tₖ) that characterize, at a current time step tₖ, a current state of the physical environment 102 at a position xᵢ in the physical environment corresponding to the node. For example, in implementations that involve simulations of physical environments with continuous fields, such as in a fluid dynamics or aerodynamics simulations, the node features fᵢ of each node can include fluid viscosity, fluid density, or any other appropriate physical aspect, at a position in the physical environment that corresponds to the node. As another example, in implementations that involve simulations of physical environments with objects, e.g., structural mechanics simulations, each node can represent a point on an object and can be associated with object-specific node features fᵢ that characterize the point on the object, e.g., the position of a respective point on the object, the pressure at the point, the tension at the point, and any other appropriate physical aspect. Furthermore, each node can additionally be associated with node features fᵢ including one or more of: a fluid density, a fluid viscosity, a pressure, or a tension, at a position in the physical environment corresponding to the node. Generally, mesh representations are not limited to the aforementioned physical environments and other types of physical environments can also be represented through a mesh and simulated using the simulation system 100.

In some implementations, the node features associated with each node at a current time step can further include a respective state of the node at each of one or more previous time steps tₖ₋₁, tₖ₋₂, . . . , t_{k-C}. For example, the node features associated with each node at the current time step can include respective node features characterizing the state of the node at each of the one or more previous time steps fᵢ(tₖ₋₁), fᵢ(tₖ₋₂), . . . , fᵢ(t_{k-C}). Such implementations can be suitable in physical environments having memory efforts (e.g., temporal dispersion), where the current state of the physical environment 102 depends on a convolution with previous states of the physical environment, e.g., through a response function (e.g., a convolution kernel). For example, the polarization density of an electromagnetic medium at a current time step generally depends on the electric field at multiple previous time steps through a dispersive permittivity. The state of a node at one or more previous time steps can also capture hidden states and/or non-reversal changes, e.g., plastic deformation, hysteresis. For computational fluid dynamics (CFD) and other related systems (e.g., continuum mechanics systems), longer histories of the state of the physical environment allow the graph neural network 150 to learn correction terms (similar to a higher-order integrator), enabling more accurate predictions and/or longer time steps, e.g., to simulate the state of the physical environment over a longer period time with fewer time steps.

The simulation system 100 operates on two mesh-based representations of the physical environment over its spatial domain D⊂ [symbol] ⁿ: (i) a fine-resolution mesh G^{f}=(V^{f}, E^{f}), where V^{f} and E^{f} are a set of nodes 11.f and a set of edges 13.f of the fine-resolution mesh 10.f respectively, and (ii) a coarse-resolution mesh G^{c}=(V^{c}, E^{c}), where V^{c} and E^{c} are a set of nodes 11.c and a set of edges 13.c of the coarse-resolution mesh 10.c respectively. The fine-resolution mesh 10.f has a higher resolution than the coarse-resolution mesh 10.c, e.g., has a larger number of nodes and/or a higher node density. In general, the coarse-resolution mesh 10.c is introduced by the simulation system 100 with the aim of promoting more efficient message-passing of the graph neural network 150, e.g., to efficiently model fast-acting or non-local dynamics.

The simulation system 100 can generate the fine-resolution 10.f and coarse-resolution 10.c meshes using a mesh generation algorithm, e.g., a Delaunay triangulation, Rupert's algorithm, algebraic methods, differential equation methods, variational methods, unstructured grid methods, among others. Alternatively, the simulation system 100 can first generate the fine-resolution mesh 10.f using a mesh generation algorithm and then average or interpolate the fine-resolution mesh 10.f to generate the coarse-resolution mesh 10.c

FIG. 1B is an illustration of example fine-resolution 10.f and coarse-resolution 10.c meshes characterizing the current state of the physical environment 102. Note, while the fine-resolution 10.f and coarse-resolution 10.c meshes are depicted in FIG. 1B as two-dimensional meshes with triangular cells (e.g., a Delaunay triangulation), the fine-resolution 10.f and coarse-resolution 10.c meshes can generally be of any dimension and can have any shaped cells.

Each node i∈V^{f} in the fine-resolution mesh 10.f is associated with current node features fᵢ^{f}(tₖ) 104.f that characterize, at the current time step tₖ, the current state of the physical environment 102 at a position xᵢ in the physical environment corresponding to the node 11.f. Pairs of nodes 11.f in the fine-resolution mesh 10.f are connected by edges 13.f that form cells 14.f. For illustrative purposes, internal nodes are identified as black circles and boundary nodes are identified as white circles with black outline.

In a similar vein, each node in the coarse-resolution mesh i∈V^{c} is associated with current node features fᵢ^{c}(tₖ) 104.c that characterize, at the current time step tₖ, the current state of the physical environment 102 at a position xᵢ in the physical environment corresponding to the node 11.c. Pairs of nodes 11.c in the coarse-resolution mesh 10.c are connected by edges 13.c that form cells 14.c. For illustrative purposes, internal nodes are identified as black circles and boundary nodes are identified as white circles with black outline.

The respective nodes in the fine-resolution 10.f and coarse-resolution 10.c meshes do not need to be coincident and therefore can characterize the current state of the physical environment 102 at different positions in the physical environment. Moreover, since the fine-resolution mesh 10.f is of higher resolution than the coarse-resolution mesh 10.c, the simulation system 100 can determine current node features 104.c for each node in the coarse-resolution mesh 10.c from the current node features 104.f of nodes in the fine-resolution mesh 10.f. For example, the simulation system 100 can average or interpolate current node features 104.f associated with groups of nodes in the fine-resolution mesh 10.f to generate the current node features 104.c associated with nodes in the coarse-resolution mesh 10.c. In some implementations, the current node features 104.c of the coarse-resolution mesh 10.c only include geometric (e.g., static) features that do not change with each time step. For example, the geometric features can include a node type that distinguishes between internal and boundary nodes, e.g., as a one-hot vector. As some further examples, the node type can indicate whether a node is a part of a physical object, a boundary of an object, part of an actuator, part of a fluid containing the object, a wall, inflow or outflow of the physical environment, a point of attachment of an object, or another feature of the physical environment.

In some implementations, the current node features 104.f and 104.c of the fine-resolution 10.f and coarse-resolution 10.c meshes can also include global features 108 of the physical environment, e.g., representations of forces being applied to the physical environment, a gravitational constant of the physical environment, a magnetic field of the physical environment, or any other appropriate feature or a combination thereof. For example, at each time step, the simulation system 100 can concatenate the global features 108 onto the current node features 104.f and 104.c associated with each node in fine-resolution mesh 10.f and each node in the coarse-resolution mesh 10.c before the graph neural network 150 processes the current state of the physical environment 102.

The graph neural network 150 includes an encoder module 110, an updater module 120, and a decoder module 130.

The encoder 110 includes one or more neural network layers. In particular, the encoder 110 can include any appropriate types of neural network layers (e.g., fully-connected layers, convolutional layers, attention layers, etc.) in any appropriate numbers (e.g., 5 layers, 25 layers, or 100 layers) and connected in any appropriate configuration (e.g., as a linear sequence of layers or as a directed graph of layers). Merely as an example, the encoder 110 can be implemented as a multilayer perceptron (MLP) with a residual connection.

At each time step, the encoder 110 processes current node features 104.f of each node in the fine-resolution mesh i∈V^{f} to generate a current node embedding vᵢ^{f}(tₖ) 114.f for the node at the time step. Similarly, at each time step, the encoder 110 processes current node features 104.c of each node in the coarse-resolution mesh i∈V^{c} to generate a current node embedding vᵢ^{c}(tₖ) 114.c for the node at the time step. Generally, a node embedding for a node represents individual properties of the node in a latent space.

At each time step, the encoder 110 can also generate a current edge embedding eᵢⱼ^{f}(tₖ) for each edge in the fine-resolution mesh 10.f and a current edge embedding eᵢⱼ^{c}(tₖ) for each edge in the coarse-resolution mesh 10.c at the time step. Generally, an edge embedding for an edge connecting a pair of nodes in a mesh represents pairwise properties of the corresponding pair of nodes in the latent space. For example, for each edge in the fine-resolution mesh 10.f or the coarse-resolution mesh 10.c, the encoder 110 can process respective current node features and/or respective positions associated with the pair of nodes i, j∈V that are connected by the edge, and generate a respective current edge embedding for the edge. More particularly, the encoder 110 can generate a current edge embedding for each edge in the fine-resolution 10.f or coarse-resolution 10.c mesh based on: respective current node features of the nodes connected by the edge, a difference between respective current node features of the nodes connected by the edge, a weighted sum of the difference between respective current nodes features of the nodes connected by the edge, respective positions of the nodes connected by the edge, a difference between the respective positions of the nodes connected by the edge, a magnitude of the difference between the respective positions of the nodes connected by the edge (e.g., a distance between the nodes connected by the edge), or a combination thereof.

The updater 120 includes a sequence of update blocks 122 that includes: (i) one or more fine-resolution update blocks 122.f, (ii) one or more coarse-resolution update blocks 122.c, (iii) one or more up-sampling update blocks 122.u, and (iv) one or more down-sampling update blocks 122.d.

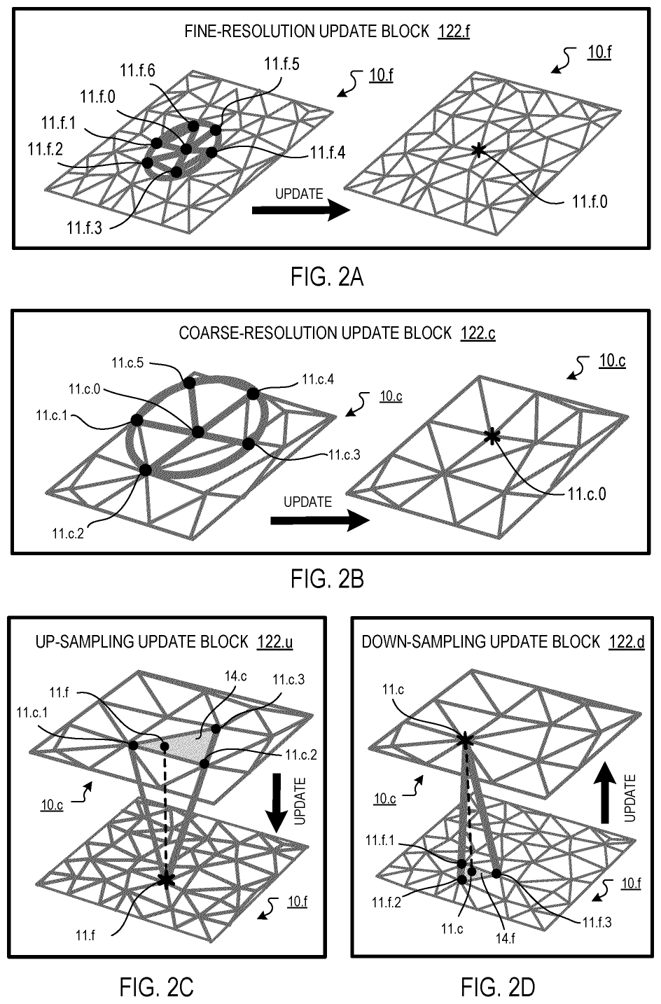

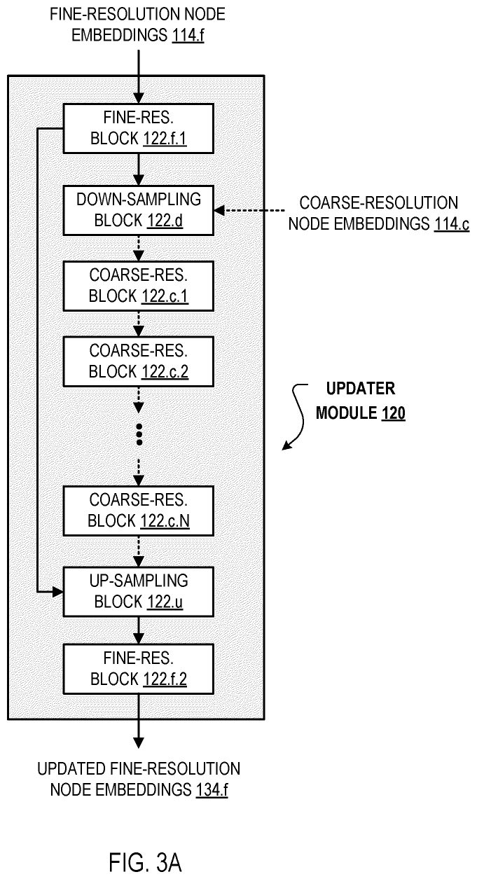

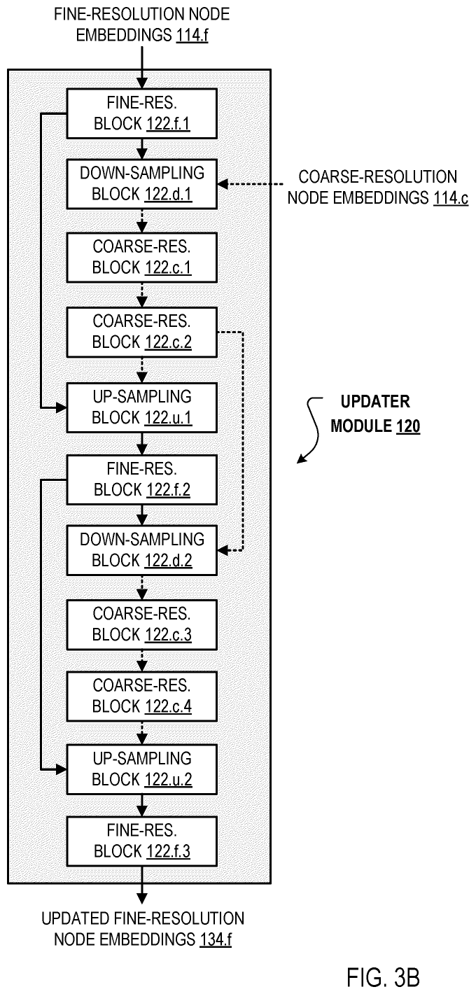

At each time step, the updater 120 processes the current node embeddings 114.f and 114.c using the sequence of update blocks 122 to generate the final updated node embeddings uᵢ^{f}(tₖ) 134.f for nodes in the fine-resolution mesh 10.f at the time step. In general, the updater 120 updates the current node embeddings 114.f and 144.c multiple times at the time step to generate the final updated node embeddings 134.f. Operations of each update block 122 are described with respect to FIGS. 2A-2D below. The update blocks 122 can be arranged in various different topologies with various numbers of blocks, e.g., to target a certain level of prediction accuracy for a certain resolution in the fine-resolution 10.f mesh. Example topologies are described with respect to FIGS. 3A and 3B below.

The decoder 130 includes one or more neural network layers. In particular, the decoder 130 can include any appropriate types of neural network layers (e.g., fully-connected layers, convolutional layers, attention layers, etc.) in any appropriate numbers (e.g., 5 layers, 25 layers, or 100 layers) and connected in any appropriate configuration (e.g., as a linear sequence of layers or as a directed graph of layers). Merely as an example, the decoder 130 can be implemented as a multilayer perceptron (MLP) with a residual connection.

At each time step, the decoder 130 processes the final updated node embeddings 134.f associated with each node in the fine-resolution mesh 10.f to generate one or more dynamics features gᵢ^{f}(tₖ) 144.f for the node at the time step. The dynamics features 144.f characterize a rate of change of a current node feature 104.f associated with the node. The dynamics features 144.f can represent a rate of change of any appropriate current node feature 104.f for nodes in the fine-resolution mesh 10.f, e.g., position, velocity, momentum, density, electromagnetic field, probability field, or any other appropriate physical aspect.

At each time step, the prediction engine 160 can determine a node feature for each node in the fine-resolution mesh 10.f at the next time step based on: (i) the current node feature 104.f of the node at the current time step, and (ii) the dynamics features 144.f of the node, e.g., by integrating the dynamics features 144.f. any appropriate number of times. For example, for first-order systems and assuming equally spaced time steps tₖ₊₁−tₖ=Δt, the prediction engine 160 can determine the node features for a node at the next time step based on the current node features 104.f at the current time step and the dynamics features 144.f corresponding to the node as:

$${f}_{i}^{f} ( {t}_{k + 1} ) = Δ {tg}_{i}^{f} ( {t}_{k} ) + {f}_{i}^{f} ( {t}_{k} ) , \qquad ( 1 )$$

since gᵢ^{f}(tₖ)=[fᵢ^{f}(tₖ₊₁)−fᵢ^{f}(tₖ)]/Δt follows from a first-order finite difference method. The prediction engine 160 can control the accuracy of such predictions, at least in part, by choosing appropriately spaced time steps Δt.

Similarly, for second-order systems, the prediction engine 160 can determine the node features for a node at a next time step based on the current node features 104.f at the current time step, the node features at a previous time step, and the dynamics feature 144.f corresponding to the node as:

$${f}_{i}^{f} ( {t}_{k + 1} ) = {( Δ t )}^{2} {g}_{i}^{f} ( {t}_{k} ) + 2 {f}_{i}^{f} ( {t}_{k} ) - {f}_{i}^{f} ( {t}_{k - 1} ) \qquad ( 2 )$$

since gᵢ^{f}(tₖ)=[fᵢ^{f}(tₖ₊₁)−2fᵢ^{f}(tₖ)+fᵢ^{f}(tₖ₋₁)]/(Δt)² follows from a second-order central difference method. Again, the prediction engine 160 can control the accuracy of such predictions, at least in part, by choosing appropriately spaced time steps Δt.

Accordingly, by determining node features for all nodes in the fine-resolution mesh 10.f at the next time step, the simulation system 100 can determine the next state of the physical environment 202. As mentioned above, the simulation system 100 can determine the node features for all nodes in the coarse-resolution mesh 10.c at the next time step by averaging or interpolating the node features associated with nodes in the fine-resolution mesh 10.f at the next time step. In implementations when the node features of the coarse-resolution mesh 10.c only include geometric features, the simulation system 100 does not need to update the node features of the coarse-resolution mesh 10.c as such features are static across time steps.

The simulation system 100 can train the graph neural network 150 using supervised learning techniques on a set of training data. The training data includes a set of training examples, where each training example specifies: (i) a respective training input that can be processed by the graph neural network 150, and (ii) a corresponding target output that the graph neural network 150 is encouraged to generate by processing the training input. The training input includes training node features f̅ᵢ^{f}(tₖ) for each node in the fine-resolution mesh 10.f and training node features f̅ᵢ^{c}(tₖ) for each node in the coarse-resolution mesh 10.c at a particular time step tₖ. In some implementations, the training node features associated with nodes in the coarse-resolution mesh 10.c only include geometric features, e.g., a node type specifying internal or boundary nodes. The target output includes one or more target dynamics features g̅ᵢ^{f}(tₖ) for each node in the fine-resolution mesh 10.f at the time step.

The simulation system 100 can train the graph neural network 150 over multiple training iterations. At each training iteration, the simulation system 100 samples a batch of one or more training examples from the training data and provides them to the graph neural network 150 that can process the training inputs specified in the training examples to generate corresponding outputs that are estimates of the target outputs, i.e., predicted dynamics features for the training inputs. The simulation system 100 can evaluate an objective function L that measures a similarity between: (i) the target outputs specified by the training examples, and (ii) the outputs generated by the graph neural network 150, e.g., a cross-entropy or squared-error objective function. For example, the objective function L can be based on an error between the predicted dynamics features gᵢ^{f}(tₖ)=d_{θ}(f̅ᵢ^{f}(tₖ), f̅ᵢ^{c}(tₖ)) for a node in the fine-resolution mesh 10.f and the target dynamics features for the node as follows:

$${L}_{θ} = {‖ {g}_{i}^{f} ( {t}_{k} ) - {\overline{g}}_{i}^{f} ( {t}_{k} ) ‖}^{2} \qquad ( 3 )$$

where d_{θ} is a function representing the graph neural network 150 model and θ are the neural network parameters of the graph neural network 150. The simulation system 100 can use a per-node and per-time step objective function as that in Eq. (3) or average the objective function over multiple nodes and/or multiple time steps. The simulation system 100 can determine gradients of the objective function, e.g., using backpropagation techniques, and can update the network parameter values of the graph neural network 150 using the gradients to optimize the objective function, e.g., using any appropriate gradient descent optimization algorithm, e.g., Adam. The simulation system 100 can also determine a performance measure of the graph neural network 150 on a set of validation data that is not used during training of the graph neural network 150.

To generate the training data, the simulation system 100 can use a simulation engine (e.g., a physics engine such as COMSOL Multiphysics from COMSOL Inc.) to simulate the state of the physical environment over one or more time steps. Particularly, the simulation system 100 simulates the state of the physical environment on a mesh that has a higher resolution than the fine-resolution mesh 10.f processed by the graph neural network 150. The simulation system 100 then generates a lower-resolution version of the simulation by interpolating (e.g., bi-linearly or bi-cubically) the simulation to the resolution of the fine-resolution mesh 10.f and the coarse-resolution mesh 10.c to generate training data based on the lower-resolution version of the simulation. Particularly, the simulation system 100 can determine the training inputs and target outputs for each training example based on the lower-resolution version(s) of the simulation. Generating the training data in this manner can increase the accuracy of the training data, thereby enabling a graph neural network 150 trained on the training data to achieve a higher simulation accuracy.

FIG. 4 is an illustration showing examples of a low-resolution simulation 410, a high-resolution simulation 420, and a lower-resolution version 430 of the high-resolution simulation 420 after interpolation. The simulations are of a Karman vortex street and were simulated with COMSOL. The grayscale in FIG. 4 shows the x-component of the velocity field. The low-resolution simulation 410 mesh is not fine enough to resolve all flow features, and the characteristic vortex shedding is suppressed. The high-resolution simulation 420 on a finer mesh correctly resolves the dynamics. The high-accuracy predictions from the high-resolution simulation 420 are interpolated onto the lower-resolution version 430 of the high-resolution simulation 420, such that vortex-shedding is still visible. The lower-resolution version 430 has the same resolution as the fine-resolution mesh 10.f and can be used by the simulation system 100 to generate training examples. In this way, the graph neural network 150 can implicitly learn the effect of smaller scales without any changes to the model code, and at inference time can achieve predictions which are more accurate than what is possible with a classical solver on a coarse scale.

After training the graph neural network 150, the simulation system 100 can be used to simulate the state of different types of physical environments. For example, from single time step predictions with hundreds or thousands of nodes during training, the simulation system 100 can effectively generalize to different types of physical environments, different initial conditions, thousands of time steps, and at least an order of magnitude more nodes.

FIG. 2A is an illustration showing operations of an example fine-resolution update block 122.f which is used by the updater 120 to perform node embedding updates on the fine-resolution mesh 10.f. As seen in FIG. 2A, each node 11.f.0 in the fine-resolution mesh 10.f receives information from each neighboring node 11.f.1-6 that is connected to the node 11.f.0 by an edge.

Each fine-resolution update block 122.f includes one or more neural network layers and is configured to process data defining the fine-resolution mesh 10.f to generate an updated node embedding v̅ᵢ^{f} of for each node in the fine-resolution mesh 10.f. In particular, one or more first neural network layers of the fine-resolution update block 122.f are configured to process an input that includes: (i) an edge embedding eᵢⱼ^{f} of an edge in the fine-resolution mesh 10.f, and (ii) respective node embeddings vᵢ^{f} and vⱼ^{f} for the pair of nodes connected by the edge, to generate an updated edge embedding ēᵢⱼ^{f} for the edge. In addition, one or more second neural network layers of the fine-resolution update block 122.f are configured to process an input that includes: (i) a node embedding vᵢ^{f} of a node in the fine-resolution mesh 10.f, and (ii) the respective updated edge embedding ēᵢⱼ^{f} of each edge connected to the node, to generate an updated node embedding of for the node. For example, the fine-resolution update block 122.f can generate the updated node embedding as:

\tilde{e}ᵢⱼ^{f}←F^{f}(eᵢⱼ^{f},vᵢ^{f},vⱼ^{f}), \tilde{v}ᵢ^{f}←S^{f}(vᵢ^{f},Σⱼ\tilde{e}ᵢⱼ^{f}) (4)
where F^{f} and S^{f} represent operations of the one or more first neural network layers and the one or more second neural network layers of the fine-resolution update block 122.f respectively. For example, the one or more first neural network layers and the one or more second neural network layers of the fine-resolution update block 122.f can each include a respective multilayer perceptron (MLP) with a residual connection.

Each fine-resolution update block 122.f can be a message-passing block with a different set of network parameters. That is, each fine-resolution update block 122.f can be identical to one another, i.e., having the same neural network architecture, but having a separate set of neural network parameters. Alternatively, the updater 120 can implement a single fine-resolution update block 122.f as a message-passing block and call the single fine-resolution update block 122.f one or more times when the block 112.f is implemented in a sequence of update blocks 122.

FIG. 2B is an illustration showing operations of an example coarse-resolution update block 122.c which is used by the updater 120 to perform node embedding updates on the coarse-resolution mesh 10.c. As seen in FIG. 2B, each node 11.c.0 in the coarse-resolution mesh 10.c receives information from each neighboring node 11.c.1-5 that is connected to the node 11.c.0 by an edge.

Each coarse-resolution update block 122.c includes one or more neural network layers and is configured to process data defining the coarse-resolution mesh 10.c to generate an updated node embedding \tilde{v}ᵢ^{c} for each node in the coarse-resolution mesh 10.c. In particular, one or more first neural network layers of the coarse-resolution update block 122.c are configured to process an input that includes: (i) an edge embedding eᵢⱼ^{c} of an edge in in the coarse-resolution mesh 10.c, and (ii) the respective node embeddings vᵢ^{c} and vⱼ^{c} for the pair of nodes connected by the edge, to update an edge embedding \tilde{e}ᵢⱼ^{c} for the edge. In addition, one or more second neural network layers of the coarse-resolution update block 122.c are configured to process an input that includes: (i) a node embedding vᵢ^{c} of a node in the coarse-resolution mesh 10.c, and (ii) the respective updated edge embedding \tilde{e}ᵢⱼ^{c} of each edge connected to the node, to generate an updated node embedding \tilde{v}ᵢ^{c} for the node. For example, the coarse-resolution update block 122.c can generate the updated node embedding as:

\tilde{e}ᵢⱼ^{c}←F^{c}(eᵢⱼ^{c},vᵢ^{c},vⱼ^{c}), \tilde{v}ᵢ^{c}←S^{c}(vᵢ^{c},Σⱼ\tilde{e}ᵢⱼ^{c}) (5)
where F^{c} and S^{c} represent operations of the one or more first neural network layers and the one or more second neural network layers of the coarse-resolution update block 122.c respectively. For example, the one or more first neural network layers and the one or more second neural network layers of the coarse-resolution update block 122.c can each include a respective multilayer perceptron (MLP) with a residual connection.

Each coarse-resolution update block 122.c can be a message-passing block with a different set of network parameters. That is, each coarse-resolution update block 122.c can be identical to one another, i.e., having the same neural network architecture, but having a separate set of neural network parameters. Alternatively, the updater 120 can use a single coarse-resolution update block 122.c as a message-passing block and call the single coarse-resolution update block 122.c one or more times when the block 122.c is implemented in a sequence of update blocks 122.

FIG. 2C is an illustration showing operations of an example up-sampling update block 122.u which is used by the updater 120 to perform node embedding updates on the fine-resolution mesh 10.f using information on the coarse-resolution mesh 10.c. As seen in FIG. 2C, each node 11.f in the fine-resolution mesh 10.f receives information from each node 11.c.1-3 in the coarse-resolution mesh 10.c that are vertices of a cell 14.c that encloses the node 11.f.

Each up-sampling update block 122.u is configured to generate data defining an up-sampling mesh G^{u}=(V^{u}, E^{u}). The set of nodes V^{u}=V^{f}∪V^{c} of the up-sampling mesh includes each node from the fine-resolution mesh 10.f and each node from the coarse-resolution mesh 10.c. The set of edges E^{u} of the up-sampling mesh includes edges between the nodes of the fine-resolution mesh 10.f and the nodes of the coarse-resolution mesh 10.c. In general, the up-sampling update block 122.u uses the edges of the up-sampling mesh to transfer information from the nodes in the coarse-resolution mesh 10.c to the nodes in the fine-resolution mesh 10.f.

The up-sampling update block 122.u can generate the edges of the up-sampling mesh as follows. For each node in the coarse-resolution mesh i∈V^{c}, the up-sampling update block 122.u identifies a cell of the fine-resolution mesh 10.f that includes the node of the coarse-resolution mesh 10.c. The up-sampling update block 122.u identifies one or more nodes in the fine-resolution mesh 10.f that are vertices of the cell j=j(i)∈V^{f}. The up-sampling update block 122.u then instantiates a respective edge kᵢⱼ∈E^{u} in the up-sampling mesh between the node of the coarse-resolution mesh 10.c and each of the identified nodes in the fine-resolution mesh 10.f. The up-sampling update block 122.u then generates an edge embedding eᵢⱼ^{u} for each edge in the up-sampling mesh based on, e.g., respective positions of the nodes connected by the edge, a difference between the respective positions of the nodes connected by the edge, a magnitude of the difference between the respective positions of the nodes connected by the edge (e.g., a distance between the nodes connected by the edge), or a combination thereof.

Each up-sampling update block 122.u includes one or more neural network layers and is configured to process data defining the up-sampling mesh to generate an updated node embedding of for each node in the fine-resolution mesh 10.f. In particular, one or more first neural network layers of the up-sampling update block 122.u are configured to process an input that includes: (i) an edge embedding eᵢⱼ^{u} of an edge in in the up-sampling mesh, and (ii) the respective node embeddings vᵢ^{c} and vⱼ^{f} of a first node in the coarse-resolution mesh 10.c and a second node in the fine-resolution mesh 10.f connected by the edge, to update the edge embedding \tilde{e}ᵢⱼ^{u} for the edge. In addition, one or more second neural network layers of the up-sampling update block 122.u are configured to process an input that includes: (i) a node embedding vᵢ^{f} of a node in the fine-resolution mesh 10.f, and (ii) the respective updated edge embedding \tilde{e}ᵢⱼ^{u} of each edge in the up-sampling mesh connected to the node, to generate an updated node embedding \tilde{v}ᵢ^{f} for the node. For example, the up-sampling update block 122.u can generate the updated node embedding as:

\tilde{e}ᵢⱼ^{u}←F^{u}(eᵢⱼ^{u},vᵢ^{c},vᵢ^{f}), \tilde{v}ᵢ^{f}←S^{u}(vᵢ^{f},Σⱼ\tilde{e}ᵢⱼ^{u}) (6)
where F^{u} and S^{u} represent operations of the one or more first neural network layers and the one or more second neural network layers of the up-sampling update block 122.u respectively. For example, the one or more first neural network layers and the one or more second neural network layers of the up-sampling update block 122.u can each include a respective multilayer perceptron (MLP) with a residual connection.

Each up-sampling update block 122.u can be a message-passing block with a different set of network parameters. That is, each up-sampling update block 122.u can be identical to one another, i.e., having the same neural network architecture, but having a separate set of neural network parameters. Alternatively, the updater 120 can use a single up-sampling update block 122.u as a message-passing block and call the single up-sampling update block 122.u one or more times when the block 122.u is implemented in a sequence of update blocks 122.

FIG. 2D is an illustration showing operations of an example down-sampling update block 122.d which is used by the updater 120 to perform node embedding updates on the coarse-resolution mesh 10.c using information on the fine-resolution mesh 10.f. As seen in FIG. 2D, each node 11.c in the coarse-resolution mesh 10.c receives information from each node 11.f.1-3 in the fine-resolution mesh 10.f that are vertices of a cell 14.f that encloses the node 11.c.

Each down-sampling update block 122.d is configured to generate data defining a down-sampling mesh G^{d}=(V^{d}, E^{d}). The set of nodes V^{d}=V^{f}∪V^{c} of the down-sampling mesh includes each node from the fine-resolution mesh 10.f and each node from the coarse-resolution mesh 10.c. The set of edges E^{d} of the down-sampling mesh includes edges between the nodes of the fine-resolution mesh 10.f and the nodes of the coarse-resolution mesh 10.c. In general, the down-sampling update block 122.d uses the edges of the down-sampling mesh to transfer information from the nodes in the fine-resolution mesh 10.f to the nodes in the coarse-resolution mesh 10.c.

The down-sampling update block 122.d can generate the edges of the down-sampling mesh as follows. For each node in the fine-resolution mesh i∈V^{f}, the down-sampling update block 122.d identifies a cell of the coarse-resolution mesh 10.c that includes the node of the fine-resolution mesh 10.f. The down-sampling update block 122.d identifies one or more nodes in the coarse-resolution mesh 10.c that are vertices of the cell j=j(i)∈V^{c}. The down-sampling update block 122.d then instantiates a respective edge kᵢⱼ∈E^{d} in the down-sampling mesh between the node of the fine-resolution mesh 10.f and each of the identified nodes in the coarse-resolution mesh 10.c. The down-sampling update block 122.d then generates an edge embedding eᵢⱼ^{d} for each edge in the down-sampling mesh based on, e.g., respective positions of the nodes connected by the edge, a difference between the respective positions of the nodes connected by the edge, a magnitude of the difference between the respective positions of the nodes connected by the edge (e.g., a distance between the nodes connected by the edge), or a combination thereof.

Each down-sampling update block 122.d includes one or more neural network layers and is configured to process data defining the down-sampling mesh to generate an updated node embedding \tilde{v}ᵢ^{c} for each node in the coarse-resolution mesh 10.c. In particular, one or more first neural network layers of the down-sampling update block 122.d are configured to process an input that includes: (i) an edge embedding eᵢⱼ^{d} of an edge in in the down-sampling mesh, and (ii) the respective node embeddings vᵢ^{f} and vⱼ^{c} of a first node in the fine-resolution mesh 10.f and a second node in the coarse-resolution mesh 10.c connected by the edge, to generate the updated edge embedding \tilde{e}ᵢⱼ^{d} for the edge. In addition, one or more second neural network layers of the down-sampling update block 122.d are configured to process an input that includes: (i) a node embedding vᵢ^{c} of a node in the coarse-resolution mesh 10.c, and (ii) the respective updated edge embedding \tilde{e}ᵢⱼ^{u} of each edge in the down-sampling mesh connected to the node, to generate an updated node embedding \tilde{v}ᵢ^{c} for the node. For example, the down-sampling update block 122.d can generate the updated node embedding as:

\tilde{e}ᵢⱼ^{d}←F^{u}(eᵢⱼ^{d},vᵢ^{f},vⱼ^{c}), \tilde{v}ᵢ^{c}←S^{d}(vᵢ^{c},Σⱼ\tilde{e}ᵢⱼ^{d}) (7)
where F^{d} and S^{d} represent operations of the one or more first neural network layers and the one or more second neural network layers of the down-sampling update block 122.d respectively. For example, the one or more first neural network layers and the one or more second neural network layers of the down-sampling update block 122.d can each include a respective multilayer perceptron (MLP) with a residual connection.

Each down-sampling update block 122.d can be a message-passing block with a different set of network parameters. That is, each down-sampling update block 122.d can be identical to one another, i.e., having the same neural network architecture, but having a separate set of neural network parameters. Alternatively, the updater 120 can use a single down-sampling update block 122.d as a message-passing block and call the single down-sampling update block 122.d one or more times when the block 122.d is implemented in a sequence of update blocks 122.

FIGS. 3A and 3B are block diagrams of example updater module 120 topologies using different sequences of update blocks 122 to update node embeddings for nodes in the fine-resolution mesh 10.f and the coarse-resolution mesh 10.c. Updates on the fine-resolution mesh 10.f are indicated with solid arrows while updates on the coarse-resolution mesh 10.c are indicated with dashed arrows. The topologies allow the updater 120 to perform efficient message-passing. Particularly, the coarse-resolution update blocks 122.c are significantly faster than the fine-resolution update blocks 122.f due to the smaller number of nodes and edges on the coarse-resolution mesh 10.c compared to the fine-resolution mesh 10.f. The coarse-resolution update blocks 122.c can also propagate information further on the coarse-resolution mesh 10.c.

Hence, updater 120 can implement an efficient updating scheme by performing a few (e.g., 1 to 4) updates on the fine-resolution mesh 10.f using a few (e.g., 1 to 4) fine-resolution update blocks 122.f to aggregate local features, downsample to the coarse-resolution mesh 10.f using a down-sampling update block 122.d, perform many (e.g., 10 to 100) updates on the coarse-resolution mesh 10.c using many (e.g., 10 to 100) coarse-resolution update blocks 122.c, upsample to the fine-resolution mesh 10.f using an up-sampling update block 122.u, and perform a few (e.g., 1 to 4) updates on the fine-resolution mesh 10.f using a few (e.g., 1 to 4) fine-resolution update blocks 122.f to compute small-scale dynamics. Such an updating scheme where the updater 120 performs updates on the fine-resolution mesh 10.f, down-samples, updates on the coarse-resolution mesh 10.c, and then up-samples back to the fine-resolution mesh 10.f is referred to as a “block-cycle”. Updater 120 can perform any number of these block-cycles as described below.

In FIG. 3A, the updater 120 uses a sequence of N+4 update blocks 122 that implements a single block-cycle. In this case, a first fine-resolution update block 122.f.1 is followed by a down-sampling update block 122.d, a sequence of multiple (N) coarse-resolution update blocks 122.f.1-N, an up-sampling update block 122.u, and a second fine-resolution update block 122.f.2. Collectively, the sequence of update blocks 122 can be denoted as “f-d-Nc-u-f”, where “f” denotes a fine-resolution update block 122.f, “c” denotes a coarse-resolution update block 122.c, “u” denotes an up-sampling update block 122.u, and “d” denotes a down-sampling update block 122.d.

In FIG. 3B, the updater 120 uses a sequence of eleven update blocks 122 that implements two block-cycles. In this case, the sequence of update blocks 122 can be denoted as “f-d-2c-u-f-d-2c-u-f”.

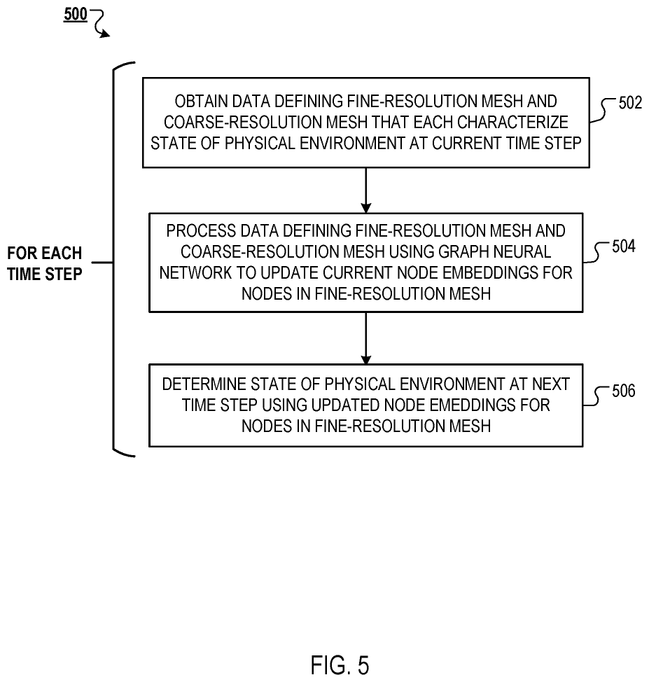

FIG. 5 is a flow diagram of an example process for simulating a state of a physical environment using a graph neural network. For convenience, the process 500 will be described as being performed by a system of one or more computers located in one or more locations. For example, a simulation system, e.g., the simulation system 100 of FIG. 1A, appropriately programmed in accordance with this specification, can perform the process 500.

For each of multiple time steps, the simulation system performs the following operations.

The simulation system obtains data defining a fine-resolution mesh and a coarse-resolution mesh that each characterize the state of the physical environment at a current time step (502). The fine-resolution mesh and coarse-resolution mesh each have respective sets of nodes and edges that can span the physical environment, a region of the physical environment, or represent one or more objects in the physical environment. The fine-resolution mesh has a higher resolution than the coarse-resolution mesh, e.g., the fine-resolution mesh has a larger number of nodes than the coarse-resolution mesh. The meshes can be one-dimensional meshes, two-dimensional meshes, three-dimensional meshes, or meshes of dimensions higher than three. In some implementations, the meshes are triangular meshes, i.e., having triangular-shaped cells. The data defining the fine-resolution mesh and the coarse-resolution mesh at the current time step includes current node embeddings for nodes in the fine-resolution mesh and current node embeddings for nodes in the coarse-resolution mesh. The data can also include current edge embeddings for edges in the fine-resolution mesh and current edge embeddings for edges in the coarse-resolution mesh.

The simulation system can obtain the data defining the fine-resolution mesh by obtaining, for each node in the fine-resolution mesh, one or more current node features for the node that characterize the state of the physical environment at a position in the physical environment corresponding to the node. For example, the node features at an initial time step can be provided by a user, e.g., through an API, and then the simulation system can perform the process 500 to obtain the node features for each subsequent time step. In some implementations, the node features include one or more of: a fluid density, a fluid viscosity, a pressure, or a tension, at the position in the physical environment corresponding to the node at the current time step. The simulation system can then process the one or more node features for each node in the fine-resolution mesh using an encoder module of the graph neural network to generate the current node embedding for the node. The simulation system can also generate the current edge embedding for each edge in the fine-resolution mesh using the encoder module based on pairwise current node features and/or respective positions for the nodes connected to the edge.

The simulation system can obtain the data defining the coarse-resolution mesh in a similar manner. In some implementations, the current node features for nodes in the coarse-resolution mesh are averaged and/or interpolated from the current node features for nodes in the fine-resolution mesh. In some implementations, the current node features for nodes in the coarse-resolution only include geometric (e.g., static) features that do not change with each time step. For example, the geometric features can include a node type that designates an internal node or a boundary node. In these cases, the simulation system can reuse the node features for nodes in the coarse-resolution mesh from previous time steps.

The simulation system processes data defining the fine-resolution mesh and the coarse-resolution mesh using an updater module of the graph neural network to update current node embeddings for nodes in the fine-resolution mesh (505).

The updater module includes: (i) one or more fine-resolution update blocks, (ii) one or more coarse-resolution update blocks, (iii) one or more up-sampling update blocks, and (iv) one or more down-sampling update blocks. The updater module can implement various different sequences of update blocks, e.g., in the form of one or more block-cycles. For example, to implement a block-cycle, the updater module can include a sequence of one or more fine-resolution update blocks, a down-sampling update block, one or more coarse-resolution update blocks, and an up-sampling update block.

Each fine-resolution update block is configured to process data defining the fine-resolution mesh using a graph neural network layer to update the current node embedding of each node in the fine-resolution mesh. For example, the fine-resolution update block can update an edge embedding for each edge in the fine-resolution mesh based on: (i) the edge embedding for the edge, and (ii) respective node embeddings of the nodes in the fine-resolution mesh that are connected by the edge. The fine-resolution update block can then update the node embedding for each node in the fine-resolution mesh based on: (i) the node embedding for the node in the fine-resolution mesh, and (ii) respective edge embeddings of each edge that is connected to the node.

Each coarse-resolution update block is configured to process data defining the coarse-resolution mesh using a graph neural network layer to update a current node embedding of each node in the coarse-resolution mesh. For example, the coarse-resolution update block can update an edge embedding for each edge in the coarse-resolution mesh based on: (i) the edge embedding for the edge, and (ii) respective node embeddings of the nodes in the coarse-resolution mesh that are connected by the edge. The coarse-resolution update block can then update the node embedding for each node in the coarse-resolution mesh based on: (i) the node embedding for the node in the coarse-resolution mesh, and (ii) respective edge embeddings of each edge that is connected to the node.

Each up-sampling update block is configured to generate data defining an up-sampling mesh. The up-sampling mesh includes: (i) each node from the fine-resolution mesh and each node from the coarse-resolution mesh, and (ii) multiple edges between the nodes of the fine-resolution mesh and the nodes of the coarse-resolution mesh. For example, for each node in the coarse-resolution mesh, the up-sampling update block can identify a cell of the fine-resolution mesh that includes the node of the coarse-resolution mesh. The up-sampling update block can then identify one or more nodes in the fine-resolution mesh that are vertices of the cell that includes the node of the coarse-resolution mesh. The up-sampling update block can then instantiate a respective edge, in the up-sampling mesh, between the node of the coarse resolution mesh and each of the identified nodes in the fine-resolution mesh. The up-sampling update block then generates an edge embedding for each edge in the up-sampling mesh based on respective positions between a pair of nodes in the up-sampling mesh that are connected by the edge, e.g., a distance between the pair of nodes in the up-sampling mesh that are connected by the edge.

Each up-sampling update block is further configured to process data defining the up-sampling mesh using a graph neural network layer to update the current node embedding of each node in the fine-resolution mesh. For example, the up-sampling update block can update an edge embedding for each edge in the up-sampling mesh based on: (i) the edge embedding for the edge, and (ii) respective node embeddings of a first node in the coarse-resolution mesh and a second node in the fine-resolution mesh that are connected by the edge. The up-sampling update block can then update the node embedding for each node in the fine-resolution mesh based on: (i) the node embedding for the node in the fine-resolution mesh, and (ii) respective edge embeddings of each edge that connects the node in the fine-resolution mesh to a corresponding node in the coarse-resolution mesh.

Each down-sampling update block is configured to generate data defining a down-sampling mesh. The down-sampling mesh includes: (i) each node from the fine-resolution mesh and each node from the coarse-resolution mesh, and (ii) multiple edges between the nodes of the fine-resolution mesh and the nodes of the coarse-resolution mesh. For example, for each node of the fine-resolution mesh, the down-sampling update block can identify a cell of the coarse-resolution mesh that includes the node of the fine-resolution mesh. The down-sampling update block can then identify one or more nodes of the coarse-resolution mesh that are vertices of the cell that includes the node of the fine-resolution mesh. The down-sampling update block can then instantiate a respective edge, in the down-sampling mesh, between the node of the fine-resolution mesh and each of the identified nodes of the coarse-resolution mesh. The down-sampling update block then generates an edge embedding for each edge in the down-sampling mesh based on respective positions between a pair of nodes in the down-sampling mesh that are connected by the edge, e.g., a distance between the pair of nodes in the down-sampling mesh that are connected by the edge.

Each down-sampling update block is further configured to process data defining the down-sampling mesh using a graph neural network layer to update the current node embedding of each node in the coarse-resolution mesh. For example, the down-sampling update block can update an edge embedding for each edge in the down-sampling mesh based on: (i) the edge embedding for the edge, and (ii) respective node embeddings of a first node in the coarse-resolution mesh and a second node in the fine-resolution mesh that are connected by the edge. The down-sampling block can then update the node embedding for each node in the coarse-resolution mesh based on: (i) the node embedding for the node in the coarse-resolution mesh, and (ii) respective edge embeddings of each edge that connects the node in the coarse-resolution mesh to a corresponding node in the fine-resolution mesh.

The simulation system determines the state of the physical environment at a next time step using the updated node embeddings for nodes in the fine-resolution mesh (506). For example, the simulation system can process the updated node embedding for each node in the fine-resolution mesh using a decoder module to generate one or more respective dynamics features corresponding to each node in the fine-resolution mesh. The simulation system can then determine the state of the physical environment at the next time step based on: (i) the dynamics features for the nodes in the fine-resolution mesh, and (ii) the node features for the nodes in the fine-resolution mesh at the current time step using a prediction engine.

In general, the graph neural network has been trained on a set of training examples to generate accurate predictions of the physical environment which it is modeling. For example, for high-accuracy predictions, the simulation system can generate a target simulation of a state of a training physical environment over one or more time steps using a simulation engine (e.g., a physics engine), where the target simulation has a higher resolution than the fine-resolution mesh processed by the graph neural network. The simulation system can then generate a lower-resolution version of the target simulation by interpolating the target simulation to a same resolution as the fine-resolution mesh processed by the graph neural network. The simulation system can then generate the one or more of the training examples using the lower-resolution version of the simulation mesh.

The above described systems and methods can be adapted for implementation on a computing system that includes first and second processors (or processor blocks) with different relative capabilities in communication with one another. In particular, where the second processor has a relatively higher processing capability or memory than the first processor. As one example, such a computing system may include a first general purpose processor and a second processor with one or more neural network accelerators. A neural network accelerator is specialized hardware that is used to accelerate neural network computations, such as a GPU (Graphics Processing Unit) or a TPU (Tensor Processing Unit). In general, a neural network accelerator is configured to perform hardware matrix multiplications, e.g., using parallel computations. A neural network accelerator can include a set of one or more multiply accumulate units (MACs) to perform such operations. As another example, the first processor may include a first, general purpose processor with a first computing capability, e.g., defined in terms of FLOPS (floating point operations per second), and/or an amount of memory available for computations. The second processor may include a second general purpose processor with a second, higher computing capability, e.g., a higher number of FLOPS, and/or a higher amount of memory available for computations. As a further example, the first processor may include a processor with a first number of neural network accelerators and the second processor may include a processor with a second, larger number of neural network accelerators.

In such a computing system, the second processor can be used for the fine-resolution mesh 10f. updates and the first processor can be used for the coarse-resolution mesh 10.c updates. That is, the graph neural network 150 can be distributed amongst the first processor and the second processor to optimally allocate computing resources for fine-resolution 10.f and coarse-resolution 10.c mesh updates. For example, the one or more fine-resolution update blocks 122.u can be implemented on the second processor and the one or more coarse-resolution update blocks 122.c can be implemented on the first processor. Since, a fine-resolution update block 122.f is generally more computationally expensive than a coarse-resolution update block 122.c, this allows the simulation system 100 to simulate a state of a physical environment more efficiently.

Thus, in some implementations, the simulation system 100 processes data defining the fine-resolution mesh 10.f by implementing the one or more fine-resolution update blocks 122.f on the second processor and processing data defining the coarse-resolution mesh 10.c by implementing the one or more coarse-resolution update blocks 122.c on the first processor. The one or more up-sampling update blocks 122.u can be implemented on the first processor and/or the second processor. Similarly, the one or more down-sampling update blocks 122.d can be implemented on the first processor and/or the second processor.

Whilst the processors (processor blocks) can operate in parallel this would be inefficient, e.g., as the inputs and outputs are only defined on the fine-resolution mesh 10.f, the first and last updates on the other meshes would be wasted. Thus, in some implementations, the simulation system 100 first processes data defining the fine-resolution mesh 10.f by implementing the one or more fine-resolution update blocks 122.f on the second processor; then processes data defining the down-sampling mesh (using either processor) to update the current node embedding of each node in the coarse-resolution mesh 10.c; then processes data defining the coarse-resolution mesh 10.c by implementing the one or more coarse-resolution update blocks 10.c on the first processor; then processes data defining the up-sampling mesh (using either processor) to update the current node embedding of each node in the fine-resolution mesh 10.f. The step of processing data defining the coarse-resolution mesh 10.c by implementing the one or more coarse-resolution update blocks on the first processor can include performing multiple updates of the data defining the coarse-resolution mesh 10.c on the first processor.

Some implementations of the above described systems and methods can be used for real-world control such as controlling a mechanical agent, e.g., a robot, in a real-world environment to perform a task, e.g., using the simulation system 100 for model-based predictive control or as part of an optimal control system controlling the agent. As one example, the simulation system 100 may be used in this way to assist a robot in manipulating a deformable object.

In more detail, the physical environment can be a real-world environment including a physical object, e.g., an object to be picked up and/or manipulated by the robot. The simulation system 100 can be used to control the robot. In particular, obtaining data characterizing the state of the physical environment at a current time step can include determining a representation of a location, a shape, or a configuration of the physical object, e.g., by capturing an image of the object. For example, the simulation system 100 can determine node features for nodes in the fine-resolution 10.f and coarse-resolution 10.c mesh from the representation of the physical object by determining the nodes features based on the, and then generating node embeddings for nodes. The simulation system 100 can determine the state of the physical environment at a next time step by determining a predicted representation of the location, the shape, or the configuration of the physical object, e.g., when subject to a force or deformation, e.g., from an actuator of the robot.

The simulation system 100 can control the robot using the predicted representation at the next time step to manipulate the physical object, e.g., using the actuator. For example, the simulation system 100 can control the robot using the predicted representation to manipulate the physical object towards a target location, a target shape, or a target configuration of the physical object by controlling the robot to optimize an objective function dependent upon a difference between the predicted representation and the target location, shape, or configuration of the physical object. Controlling the robot can include simulation system 100 providing control signals to the robot based on the predicted representation to cause the robot to perform actions, e.g., using the actuator, to manipulate the physical object to perform a task.

Some examples of the simulation system 100 involve controlling the robot, e.g., an actuator of the robot, using a reinforcement learning process with a reward that is at least partly based on a value of the objective function, to learn to perform a task which involves manipulating the physical object. Alternatively or in addition, this may involve the simulation system 100 controlling the robot using a model predictive control (MPC) process or using an optimal control process.

FIGS. 6A and 6B are plots of experimental data showing mean squared error (MSE) versus minimum edge length (edge min) for: (i) a reference simulator (COMSOL), (ii) two variations of a MeshGraphNets (MGN) learned solver with 15 message-passing steps (mps) and 25 mps respectively, and (iii) fine-resolution meshes of example simulation systems 100-1 and 100-2 using two different updater module topologies with 15 mps and 25 mps respectively. The same coarse-resolution mesh is used for each of the simulation systems 100-1 and 100-2 with a fixed resolution corresponding to a minimum edge length of 10⁻². The updater module of the first simulation system 100-1 includes a sequence of fifteen blocks that implements a single block-cycle, “f-d-11c-u-f”, thereby totaling 15 mps. The updater module of the second simulation system 100-2 includes a sequence of twenty-five blocks that implements two block-cycles, “3f-d-6c-u-3f-d-6c-u-3f”, thereby totaling 25 mps.

A set of training data for the MGN models and the example simulation systems includes one thousand trajectories of incompressible flow past a long cylinder in a channel, simulated with COMSOL. Each trajectory includes two hundred time steps. The parameters, e.g., radius and position of the obstacle, inflow initial velocity and mesh resolution, vary between the trajectories. Notably, the mesh resolution covers a wide range from a hundred to tens of thousands of nodes.

The effects of mesh resolution on each of the simulation systems' predictions are evaluated on a set of validation data that includes five hundred trajectories with varying mesh resolutions, but otherwise constant initial conditions. The minimum edge length (edge min) of these meshes ranges from 10⁻² to 10⁻³. As analytical solutions are in general not available for nontrivial simulation setups, high-resolution simulations are commonly used as a proxy for the “ground-truth” solution of the underlying partial differential equation (PDE). Here, the ground truth reference trajectory (u_{ref}) was generated by running COMSOL at the maximum resolution in this validation dataset (edge min=10⁻²). The error is measured by performing next-step prediction on the validation dataset using a learned model or a classical solver at a given mesh resolution, linearly interpolating the ground-truth trajectory onto the simulation mesh, and computing the MSE.

The results in FIG. 6A show a considerable reduction in the MSE for the simulation systems 100-1 and 100-2 as compared to the MGN baselines, keeping the overall number of mps fixed. The second simulation system 100-2 with 25 mps manages to track the spatial convergence curve of the reference simulator closely. Hence, the simulation system 100 is effective at resolving the message-passing bottleneck for the underlying problem, and can achieve higher accuracy with the same number of mps as other graph neural network models. Message passing speed becomes a bottleneck for MGN performance for high resolution meshes; but this bottleneck is lifted using a simulation system 100 with multiscale mesh methods.

In FIG. 6B, both the MGN models (15 mps and 25 mps) and the simulation systems 100-1 and 100-2 were trained on a training dataset with mixed mesh resolution, but with high-accuracy predictions as described above (e.g., see FIG. 4). This indicates that the learned solver can learn an effective model of the subgrid dynamics, and can make accurate predictions even at very coarse mesh resolutions. The effect extends up to edge lengths of 10⁻² which correspond to a very coarse mesh with only around a hundred nodes. However, this method does not alleviate the message propagation bottleneck for MGN models, and errors increase above the convergence curve for edge lengths below 0.0016. Thus, if a highly resolved output mesh is desired, accuracy is still limited using MGN. For a method that performs well both on low- and very high-resolution meshes, a simulation system 100 with high-accuracy labels can be used. For the second simulation system 100-2 with 25 mps, the error stays below the reference solver curve at all resolutions, with all the performance benefits of the simulation system 100.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers for simulating a state of a physical environment, the method comprising, for each of a plurality of time steps:
obtaining data defining a fine-resolution mesh and a coarse-resolution mesh that each characterize the state of the physical environment at the current time step, wherein the fine-resolution mesh has a higher resolution than the coarse-resolution mesh;
processing data defining the fine-resolution mesh and the coarse-resolution mesh using a graph neural network, wherein the graph neural network comprises: (i) one or more fine-resolution update blocks, (ii) one or more coarse-resolution update blocks, and (iii) one or more up-sampling update blocks, wherein:
each fine-resolution update block is configured to process data defining the fine-resolution mesh using a graph neural network layer to update a current node embedding of each node in the fine-resolution mesh;
each coarse-resolution update block is configured to process data defining the coarse-resolution mesh using a graph neural network layer to update a current node embedding of each node in the coarse-resolution mesh; and
each up-sampling update block is configured to:
generate data defining an up-sampling mesh that comprises: (i) each node from the fine-resolution mesh and each node from the coarse-resolution mesh, and (ii) a plurality of edges between the nodes of the fine-resolution mesh and the nodes of the coarse-resolution mesh; and
process data defining the up-sampling mesh using a graph neural network layer to update the current node embedding of each node in the fine-resolution mesh; and
determining the state of the physical environment at a next time step using the updated node embeddings for the nodes in the fine-resolution mesh.

2. The method of claim 1, wherein generating the up-sampling mesh comprises, for each node of the coarse-resolution mesh:
identifying a cell of the fine-resolution mesh that includes the node of the coarse-resolution mesh;
identifying one or more nodes in the fine-resolution mesh that are vertices of the cell that includes the node of the coarse-resolution mesh; and
instantiating a respective edge, in the up-sampling mesh, between the node of the coarse resolution mesh and each of the identified nodes in the fine-resolution mesh.

3. The method of claim 2, further comprising, for each edge in the up-sampling mesh:
generating an edge embedding for the edge based on a distance between a pair of nodes in the up-sampling mesh that are connected by the edge.

4. The method of claim 1, wherein processing data defining the up-sampling mesh using a graph neural network layer to update the current node embedding of each node in the fine-resolution mesh comprises:
updating an edge embedding for each edge in the up-sampling mesh based on: (i) the edge embedding for the edge, and (ii) respective node embeddings of a first node in the coarse-resolution mesh and a second node in the fine-resolution mesh that are connected by the edge; and
updating the node embedding for each node in the fine-resolution mesh based on: (i) the node embedding for the node in the fine-resolution mesh, and (ii) respective edge embeddings of each edge that connects the node in the fine-resolution mesh to a corresponding node in the coarse-resolution mesh.

5. The method of claim 1, wherein each up-sampling block updates the current node embeddings of the nodes in the fine-resolution mesh based at least in part on the current node embeddings of the nodes in the coarse-resolution mesh.

6. The method of claim 1, wherein the graph neural network further comprises one or more down-sampling update blocks, wherein each down-sampling update block is configured to:
generate data defining a down-sampling mesh that comprises: (i) each node from the fine-resolution mesh and each node from the coarse-resolution mesh, and (ii) a plurality of edges between the nodes of the fine-resolution mesh and the nodes of the coarse-resolution mesh; and
process data defining the down-sampling mesh using a graph neural network layer to update the current node embedding of each node in the coarse-resolution mesh.

7. The method of claim 6, wherein generating the down-sampling mesh comprises, for each node of the fine-resolution mesh:
identifying a cell of the coarse-resolution mesh that includes the node of the fine-resolution mesh;
identifying one or more nodes of the coarse-resolution mesh that are vertices of the cell that includes the node of the fine-resolution mesh; and
instantiating a respective edge, in the down-sampling mesh, between the node of the fine-resolution mesh and each of the identified nodes of the coarse-resolution mesh.

8. The method of claim 7, further comprising, for each edge in the down-sampling mesh:
generating an edge embedding for the edge based on a distance between a pair of nodes in the down-sampling mesh that are connected by the edge.

9. The method of claim 6, wherein processing data defining the down-sampling mesh using a graph neural network layer to update the current node embedding of each node in the coarse-resolution mesh comprises:
updating an edge embedding for each edge in the down-sampling mesh based on: (i) the edge embedding for the edge, and (ii) respective node embeddings of a first node in the coarse-resolution mesh and a second node in the fine-resolution mesh that are connected by the edge; and
updating the node embedding for each node in the coarse-resolution mesh based on: (i) the node embedding for the node in the coarse-resolution mesh, and (ii) respective edge embeddings of each edge that connects the node in the coarse-resolution mesh to a corresponding node in the fine-resolution mesh.

10. The method of claim 6, wherein each down-sampling block updates the current node embeddings of the nodes in the coarse-resolution mesh based at least in part on the current node embeddings of the nodes in the fine-resolution mesh.

11. The method of claim 1, wherein the graph neural network has been trained on a set of training examples, wherein one or more of the training examples are generated by operations comprising:
generating a target simulation of a state of a training physical environment over one or more time steps using a simulation engine, wherein the target simulation has a higher resolution than the fine-resolution mesh processed by the graph neural network;
generating a lower-resolution version of the target simulation by interpolating the target simulation to a same resolution as the fine-resolution mesh processed by the graph neural network; and
generating the training examples using the lower-resolution version of the simulation mesh.

12. The method of claim 1, wherein obtaining data defining the state of the physical environment at the current time step comprises, for each node in the fine-resolution mesh:
obtaining one or more node features for the node, wherein the node corresponds to a position in the physical environment, and wherein the node features characterize a state of the corresponding position in the physical environment; and
processing the node features using one or more neural network layers of the graph neural network to generate the current embedding for the node.

13. The method of claim 12, wherein for each node in the fine-resolution mesh, the node features for the node comprise one or more of: a fluid density feature, a fluid viscosity feature, a pressure feature, or a tension feature.

14. The method of claim 12, wherein the graph neural network further comprises a decoder block, and wherein determining the state of the physical environment at the next time step comprises:
processing the updated node embedding for each node in the fine-resolution mesh to generate one or more respective dynamics features corresponding to each node in the fine-resolution mesh; and
determining the state of the physical environment at the next time step based on: (i) the dynamics features for the nodes in the fine-resolution mesh, and (ii) the node features for the nodes in the fine-resolution mesh at the current time step.

15. The method of claim 1, wherein the fine-resolution mesh and the coarse-resolution mesh are each three-dimensional meshes.

16. The method of claim 1, wherein the fine-resolution mesh and the coarse-resolution mesh are each triangular meshes.

17. The method of claim 1, wherein the fine-resolution mesh and the coarse-resolution mesh each span the physical environment.

18. The method of claim 1, wherein for each time step, a number of nodes in the fine-resolution mesh is greater than a number of nodes in the coarse-resolution mesh.

19. (canceled)

20. (canceled)

21. (canceled)

22. One or more non-transitory computer storage media storing instructions that when executed by one or more computers cause the one or more computers to perform operations for simulating a state of a physical environment, the operations comprising, for each of a plurality of time steps:
obtaining data defining a fine-resolution mesh and a coarse-resolution mesh that each characterize the state of the physical environment at the current time step, wherein the fine-resolution mesh has a higher resolution than the coarse-resolution mesh;
processing data defining the fine-resolution mesh and the coarse-resolution mesh using a graph neural network, wherein the graph neural network comprises: (i) one or more fine-resolution update blocks, (ii) one or more coarse-resolution update blocks, and (iii) one or more up-sampling update blocks, wherein:
each fine-resolution update block is configured to process data defining the fine-resolution mesh using a graph neural network layer to update a current node embedding of each node in the fine-resolution mesh;
each coarse-resolution update block is configured to process data defining the coarse-resolution mesh using a graph neural network layer to update a current node embedding of each node in the coarse-resolution mesh; and
each up-sampling update block is configured to:
generate data defining an up-sampling mesh that comprises: (i) each node from the fine-resolution mesh and each node from the coarse-resolution mesh, and (ii) a plurality of edges between the nodes of the fine-resolution mesh and the nodes of the coarse-resolution mesh; and
process data defining the up-sampling mesh using a graph neural network layer to update the current node embedding of each node in the fine-resolution mesh; and
determining the state of the physical environment at a next time step using the updated node embeddings for the nodes in the fine-resolution mesh.

23. A system comprising:
one or more computers; and
one or more storage devices communicatively coupled to the one or more computers, wherein the one or more storage devices store instructions that, when executed by the one or more computers, cause the one or more computers to perform operations for simulating a state of a physical environment, the operations comprising, for each of a plurality of time steps:
obtaining data defining a fine-resolution mesh and a coarse-resolution mesh that each characterize the state of the physical environment at the current time step, wherein the fine-resolution mesh has a higher resolution than the coarse-resolution mesh;
processing data defining the fine-resolution mesh and the coarse-resolution mesh using a graph neural network, wherein the graph neural network comprises: (i) one or more fine-resolution update blocks, (ii) one or more coarse-resolution update blocks, and (iii) one or more up-sampling update blocks, wherein:
each fine-resolution update block is configured to process data defining the fine-resolution mesh using a graph neural network layer to update a current node embedding of each node in the fine-resolution mesh;
each coarse-resolution update block is configured to process data defining the coarse-resolution mesh using a graph neural network layer to update a current node embedding of each node in the coarse-resolution mesh; and
each up-sampling update block is configured to:
generate data defining an up-sampling mesh that comprises: (i) each node from the fine-resolution mesh and each node from the coarse-resolution mesh, and (ii) a plurality of edges between the nodes of the fine-resolution mesh and the nodes of the coarse-resolution mesh; and
process data defining the up-sampling mesh using a graph neural network layer to update the current node embedding of each node in the fine-resolution mesh; and
determining the state of the physical environment at a next time step using the updated node embeddings for the nodes in the fine-resolution mesh.
